(19) United States
(12) Patent Application Publication
(10) Pub. No.: US 2002/0076569 A1
(43) Pub. Date: Jun. 20, 2002

(54) Structural flexible composite veneer laminate

(76) Inventor: Jean-Pierre Giguere, Boucherville (CA)

Correspondence Address: WILDMAN, HARROLD, ALLEN & DIXON, 225 WEST WACKER DRIVE, CHICAGO, IL, 60606, US

(21) Appl. No.: 09/930,354

(22) Filed: Aug. 15, 2001

(30) Foreign Application Priority Data
Aug. 23, 2000 (CA) 2,316,593

(51) Int. Cl. B27G 1/00

(52) U.S. Cl. 428/541; 52/390; 144/332

(57) ABSTRACT

A flexible composite veneer laminate is disclosed comprising a thick core of flexible wood, a thin veneer sheet bonded to one outside surface of the thick core, and a thin paper sheet bonded the other outside surface of said thick core, the thick core of flexible wood having a flexibility necessary to allow the flexible composite veneer to be folded on itself so as to make a circle having a radius of 30 centimeters.

### FIELD OF THE INVENTION

The invention relates to composite veneer laminates, and in particular to wood veneer laminates adapted to be used for furniture making, cabinet making, and other types of constructions and/or finishes wherein a final or external wood finish is required or desired.

### BACKGROUND OF THE INVENTION

Wood veneer is highly desirable for many purposes, in particular furniture making, cabinet making, door making and any other type of construction wherein the look and feel of a wood finish is required or desired for aesthetic or functional purposes. Since solid wood construction, in particular for furniture, cabinets and doors, is extremely expensive and may increasingly become more expensive as high-quality wood supplies dwindle, wood veneer finish may become more and more important for certain industries. In particular, plywood or other types of woods without a visually appealing finish may increasingly be used as the core of a particular construction, or furniture and wood veneer may be applied thereon in order to finish the construction or furniture with an aesthetically-pleasing look.

Wood veneer and composite veneer laminates are well-known in the art and have been in use for a very great number of years. However, the great majority of wood veneer is thin (i.e. very thin), in the order of 1/16 to 1/32 of an inch thick.

The thickness of known veneers comprises limitations which in some cases may be quite important. The thinness of known wood veneer or composite laminate veneer is such that this veneer does not have any structural strength and therefore does not add any structural integrity to the underlying rough, i.e. unfinished, surface. Therefore, in accordance with traditional techniques used in furniture making, cabinet making or other industries which use wood veneer, furniture is constructed and/or assembled using cheap, or visually unappealing wood such as plywood or knotty wood, then the wood veneer (i.e. the thin wood veneer) is applied thereon in order to give a visually appealing finish. Therefore, for certain types of constructions, i.e. in particular in the making of curved and/or rounded furniture, traditional construction techniques require the use of a mould or form or other type of shaping structure onto which the structural component is placed in order to take the form of the mould. For example, plywood may be made to be formed on a mould, and once the plywood has acquired the shape of the mould, a thin wood veneer is applied on one exterior surface in order to give the finished look. The structural strength of the furniture is provided by the plywood with little or no strength contributed by the veneer. This process may understandably be laborious, complicated and expensive, and may add unnecessary or needless steps to the construction of a piece of furniture, cabinet or other.

Therefore, it would be advantageous to provide for a flexible, thick composite veneer laminate which is of a sufficient thickness to provide structural strength and rigidity to a construction, such as furniture, cabinets or other.

It would further be advantageous to provide for a flexible, thick composite veneer laminate comprising a thick, flexible piece of wood onto which is applied a thin laminate of finished wood. Said application may be done under high pressure.

It would further be advantageous to provide for a flexible, thick composite veneer laminate comprising a plurality of layers of flexible wood and finally provided with a veneer of finishing wood on one outside surface. Said veneer may be applied under high pressure.

### SUMMARY OF THE INVENTION

The present invention is directed to a structural, flexible composite veneer laminate. In accordance with a broad aspect of the present invention, there may be provided for a single thick wood core comprising substantially first and second flat, spaced-apart outer surfaces, onto which first surface may be bonded a thin wood veneer, and on which opposed surface may be bonded a core paper. As may be understood, the expression “single thick wood core” may be understood to mean a wooden layer of sufficient thickness to allow the composite veneer laminate of the present invention to have structural strength while at the same time allow for the composite veneer laminate to be flexible in order to allow for it to be applied to curved or rounded surfaces. Not all types of wood may be suitable to be used for this type of composite veneer laminate. In particular, the type of wood which may be suitable for this application may be fuma, ceiba, and other such woods which may be found principally in tropical areas. Thus, as may be understood, the single thick wood core may be of a thickness which is relatively unheard of in the lamination industry, and may, for example, be in the range of ⅛ to ⅙ of an inch thick. In accordance with the properties of, for example, fuma, a sheet of fuma ⅙ of an inch thick may be flexible enough to be folded about itself in a radius of approximately 12 inches. Yet, while being flexible enough to bend about itself in a radius of 12 inches, fuma is structurally sound enough to be used as a structural component in furniture. For example, a piece of fuma of such thickness may be used as the headboard of a bed, or as a vertical wall of a desk, dresser, or other such furniture.

Even though fuma may have outstanding structural property (i.e. stiffness, rigidity, and structural strength) and may also be flexible, it may not have a visually appealing look, i.e. finish to it. Therefore, in order to compensate for this shortcoming, the present invention may provide for the application onto one of the surfaces of the fuma of a thin veneer which may be of any number of types of woods, such as maple, oak, birch, ash or any other such wood, i.e. hardwood, which may typically be used as veneer. The thin wood veneer may have a thickness anywhere in the range of 1/64 to 1/32 of an inch and may, in accordance with known techniques, be applied to the surface of the fuma.

Further, in order to add greater structural rigidity, the structural flexible composite veneer laminate of the present invention may be provided with a paper core layer on the second surface of the fuma, i.e. the surface not being provided with wood veneer. In accordance with this embodiment, the cardboard core paper may be any known or required or desired type of cardboard such as, for example, core paper, manufactured by Kimberly-Clark. In accordance with an alternative embodiment of the present invention, the cardboard core paper may be replaced by a paper layer of any other construction, such as, for example, a cotton layer, rubber layer, soft metal layer or any other substitute, keeping in mind that the thickness and properties of these alternative embodiments may have to have similar properties as the cardboard paper.

In accordance with a further embodiment of the present invention, the structural flexible composite veneer laminate of the present invention may be provided with more than one thick wood core layer. For example, in applications wherein more structural rigidity and strength is required than may be provided by a single thick wood core, the use of an additional wooden cores may be provided, i.e. one or more. For example, if the basic unit comprises, in order, a thin wood laminate, single thick wood core, and cardboard paper, may be in addition fitted with a further wooden core onto the cardboard paper. Thus, in accordance with this embodiment, there may be provided for a structural flexible composite veneer laminate comprising, in order, a thin wood laminate, a thick wood core, a cardboard paper, and an additional thick wood core. The addition of the second wood core will significantly (i.e. may up to double) the strength of the veneer laminate, and at the same time may be as flexible, i.e. almost as flexible, as the veneer laminate with one wooden core.

In accordance with this alternative embodiment, the type of wood which may be used for the two or more wooden cores may be the same, i.e. each of them may be fuma, ceiba, etc., or each one may be a different type of wood from the other, i.e. for example, one layer may be fuma, while the second layer may be ceiba. In accordance with this embodiment, the structural flexible composite veneer laminate may be further fitted with a second cardboard paper on the outside of the second wood core. In addition to the types of wood described above, the wooden cores may comprise the following types of wood: sumoma, obeche, koto, okoume, meranti and lauan.

The apposition of the wood veneer and of the core paper onto the layers of wood may be effected in any known, required or desired manner, in particular, glue, or a thermoglue, may be used, such as, for example, PVA, polyvinyl acetate, or any other type of glues which are well known in the art may be used. In addition to the glue, one may use pressure, or any other method in order to effect the proper bonding of the composite veneer laminate.

### BRIEF DESCRIPTION OF THE DRAWINGS

FIG. 1 is a perspective view illustrating a structural flexible composite veneer laminate showing the internal structure thereof;

FIG. 2 is a side elevation view of the structural flexible composite veneer laminate of FIG. 1;

FIG. 3 is a perspective view illustrating an alternative embodiment of the structural flexible composite veneer laminate in accordance with the present invention.

FIG. 4 is a top elevation view of the structural flexible composite veneer laminate of the present invention being installed in its final position as a component of a piece of furniture.

FIG. 5 is a perspective view of an additional embodiment of the present invention.

### DETAILED DESCRIPTION OF THE FIGURES

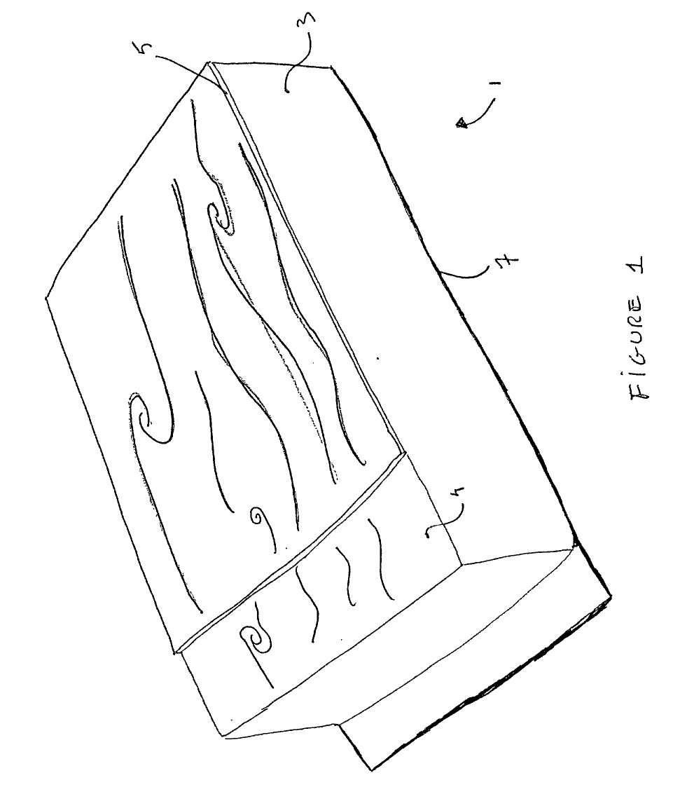

FIG. 1 illustrates a perspective view of a particular embodiment of a structural flexible composite veneer laminate 1 in accordance with the present invention. In its most basic form, the composite veneer laminate 1 may comprise a single thick wood core 3 having opposed first and second substantially flat surfaces 4, 6 (6 is not shown). The composite veneer laminate 1 may further comprise a thin wood veneer 4 bonded onto first opposed surface 4, said thin wood veneer may substantially cover the whole of surface 4.

In addition, the composite veneer laminate 1 may further comprise a core paper 7 which may be bonded onto second opposed surface 6 of wood core 3.

As illustrated in FIG. 1, the composite veneer laminate is shown as being rectangular in shape, and may, in accordance with a particular embodiment, be in the form of a strip. However, as may be understood, the shape of the composite veneer laminate is not restricted to the illustration of FIG. 1, and may be any shape required or desired. Further, as illustrated in FIG. 1, the thicknesses of the various components, namely the wood core 3, thin wood veneer 5 and core paper 7 have been exaggerated for the sake of clarity, i.e. the figure is not necessarily to scale. In accordance with a particular embodiment, the thin wood veneer may have a thickness of 1/64 to 1/32 of an inch, the wood core may have a thickness of up to ¼ of an inch, and the core paper may have a thickness of a few mils, i.e. 2 to 20 mils.

In accordance with the physical properties of the type of wood selected for the wood core, the composite veneer laminate 1 may have the ability to be bent about a radius which may allow a strip 4 inches wide to make a circle about itself having a radius of 12 to 18 inches. Thus, as may be understood, the composite veneer laminate may therefore be used directly as a structural component in furniture making, cabinet making and other types of decorative arts.

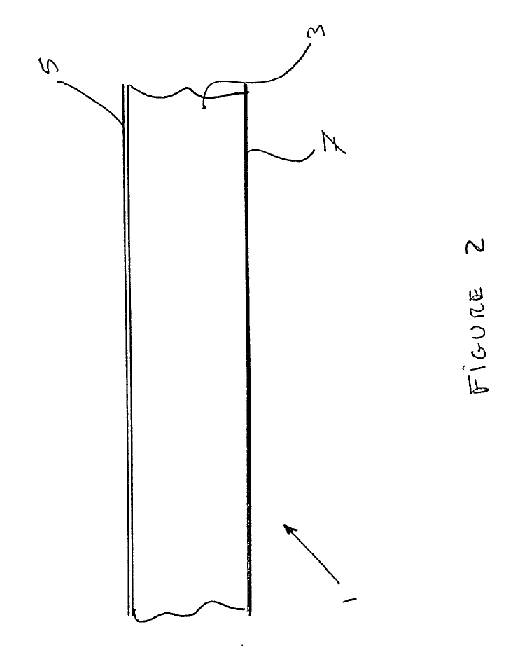

FIG. 2 illustrates a side elevation view of the composite veneer laminate of FIG. 1 illustrating the approximate relative thicknesses of the various components thereof. As may be understood, wood veneer 5 is illustrated as being very thin in comparison to the thickness of the wood core 3. Further, the core paper 7 is illustrated as being even thinner than the wood veneer 5.

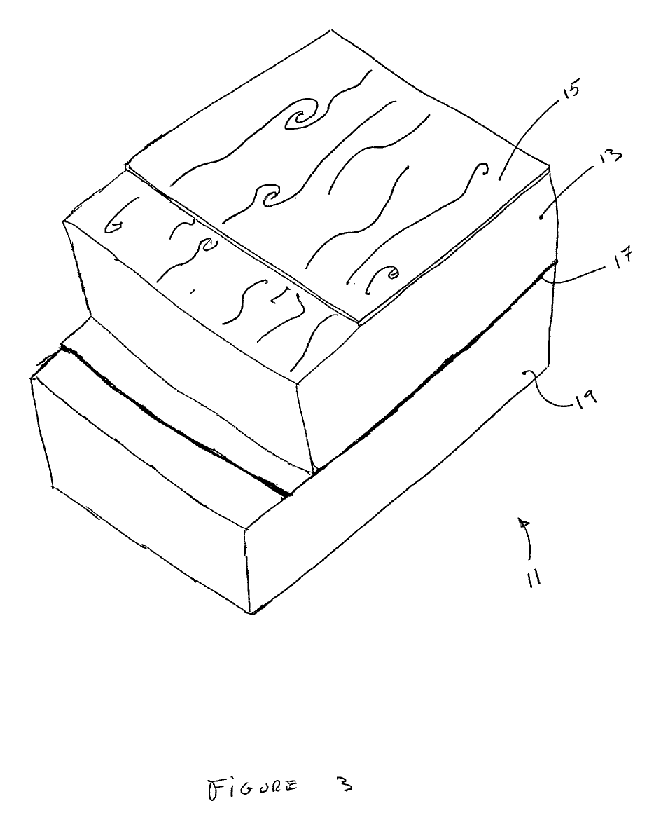

FIG. 3 illustrates an alternative embodiment 11 of the composite veneer laminate illustrated in FIGS. 1 and 2. As may be seen, the composite wood laminate 11 comprises, in addition to thin wood veneer 11, first wood core 13 and core paper 17, an additional wood core 19. Thus, in accordance with this variant, the composite veneer laminate 11 may have greater structural strength than that illustrated in FIGS. 1 and 2, yet at the same, since the wood cores 13 and 19 may be equally flexible, the flexibility of the resulting composite veneer laminate may not be affected, or if it is affected, such reduction in flexibility may be small or negligible.

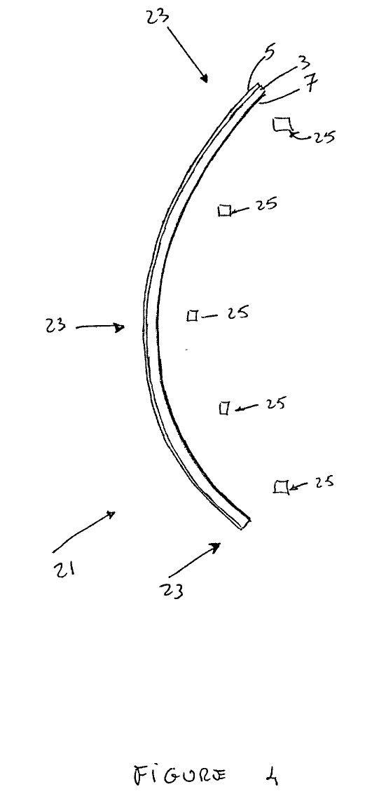

FIG. 4 illustrates a top elevation view of a structural flexible composite veneer laminate 21 being moved in the direction of motion arrows 23 to be affixed onto supports 25. The configuration of supports 25 is meant to be an example of a type of furniture which would require both a structural component, and a finished veneer look. The illustration is not limitative and is to serve only as illustrative of a particular example of our application, being understood that any other configuration shape form may be used. As may been seen, the apposition of the composite veneer laminate onto the supports 25 may be effected in one operation, by the affixing of the composite veneer laminate 21 onto the supports of 25. As may be seen, this one-step procedure may eliminate the use of a structural component, i.e., for example, a piece of plywood which would otherwise be affixed in a first step onto the supports 25. Following this step, a wood veneer would have to be applied onto the outside surface of the plywood. The present invention overcomes this two-step procedure by providing a handy, one-step method of installing a finished wood veneer covered structural component, illustrated as the composite veneer laminate 21.

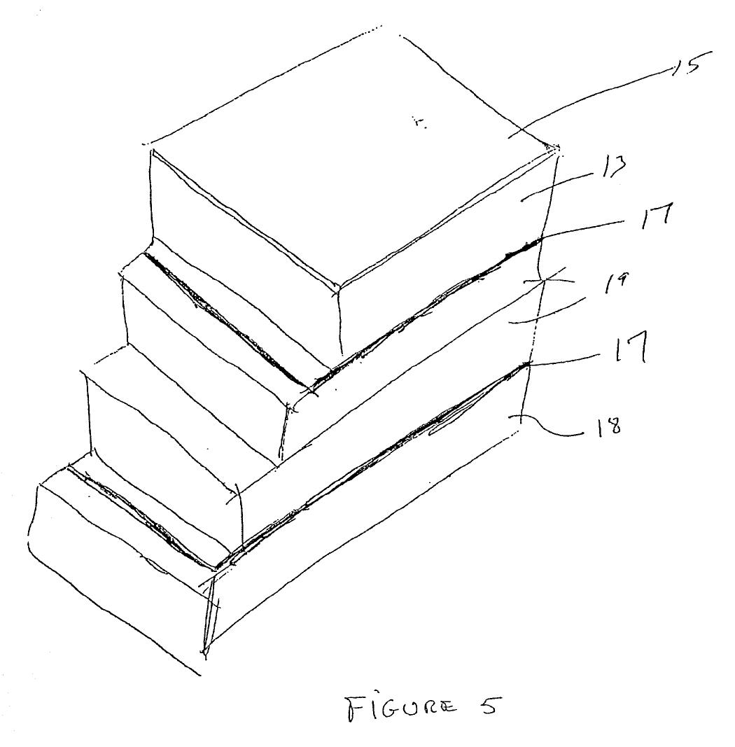

FIG. 5 is a further embodiment, showing a multiple composite veneer laminate, similar to that shown in FIG. 3, but with an additional layer of core paper 17, and a third wood core 18.

I claim:

1. A flexible composite veneer laminate suitable for applications where said veneer is to provide structural strength,
said veneer comprising a thick core of flexible wood, said thick core comprising opposed first and second surfaces,
a thin first veneer sheet bonded to said first surface,
a thin paper sheet bonded to said second surface, said thick core of flexible wood having a flexibility necessary to allow said flexible composite veneer to be folded on itself so as to have a radius of thirty centimeters.

2. The flexible composite veneer of claim 1 wherein said thick core has a thickness of between ⅛ to ¼ of an inch.

3. The flexible composite veneer of claim 1 wherein said thin paper is bonded to said second surface through the use of a thermo setting adhesive.
